(19) United States
(12) Patent Application Publication
(10) Pub. No.: US 2025/0222988 A1
(43) Pub. Date: Jul. 10, 2025

(54) FRONT STRUCTURE OF VEHICLE BODY

(71) Applicants: Hyundai Motor Company, Seoul (KR); Kia Corporation, Seoul (KR)

(72) Inventors: Jejoon Lee, Hwaseong-si (KR); Seungho Noh, Hwaseong-si (KR)

(21) Appl. No.: 18/966,433

(22) Filed: Dec. 3, 2024

(30) Foreign Application Priority Data
Jan. 4, 2024 (KR) 10-2024-0001599

(51) Int. Cl. B62D 25/14; B62D 21/03; B62D 25/16; B62D 27/02

(52) U.S. Cl. CPC B62D 25/145; B62D 21/03; B62D 25/16; B62D 27/023

(57) ABSTRACT

A front structure of a vehicle body includes a dash panel and a dash reinforcement apparatus connected to a rear of the dash panel. The dash reinforcement apparatus includes a longitudinal member arranged in a length direction of the vehicle body and a transverse member arranged in a width direction of the vehicle body.

### CROSS-REFERENCE TO RELATED APPLICATIONS

This application claims the benefit of Korean Patent Application No. 10-2024-0001599, filed on Jan. 4, 2024, which application is hereby incorporated herein by reference.

### TECHNICAL FIELD

The present invention relates to a front structure of a vehicle body.

### BACKGROUND

The existing dash lower reinforcement panel functions to assist the front apron, and the size and position of the members are dependent on the front apron, which is the main member.

The main load entering the vehicle body is supported by the front apron member, and the dash lower reinforcement panel plays a secondary role by supporting the rear of the dash panel.

Additionally, the rolling load of the vehicle body received by the dash panel is responded to by one member, forming one load path.

In a vehicle with a skateboard frame, the front apron cannot extend to the lower dash due to the presence of the front frame, and therefore, a configuration that reinforces the lower dash is required.

The information contained in this background section has been prepared to promote understanding of the background of embodiments of the invention and may include matters that are not already known prior art.

### SUMMARY

The present invention relates to a front structure of a vehicle body. Particular embodiments relate to a front structure of a vehicle body capable of increasing the strength of a dash panel.

Embodiments of the present disclosure provide a front structure of a vehicle body having reinforced dash panel strength.

A front structure of a vehicle body according to exemplary embodiments may include a dash panel and a dash reinforcement unit connected to a rear of the dash panel and including one or more longitudinal members arranged in the length direction of the vehicle body and one or more transverse members arranged in the width direction of the vehicle body.

The front structure according to exemplary embodiments may further include a chassis frame, and the dash panel may be provided on an upper portion of the chassis frame.

The transverse member may include a lower outer transverse member which overlaps a connection portion of the chassis frame and the dash panel and is arranged on the outer side in the width direction of the dash panel, respectively.

The transverse member may further include a lower connecting transverse member positioned between the lower outer transverse members on either side.

The longitudinal member may include a longitudinal direction main member, which is arranged on both sides of the dash panel and connected to the lower outer transverse member.

The transverse member may include an upper transverse direction member connected to the upper portion of the longitudinal direction main member.

The upper transverse direction member may include an upper transverse direction connecting member provided between the longitudinal direction main members and an upper transverse direction outer member arranged on both outer sides of the longitudinal direction main member.

The transverse member may include a central transverse direction member positioned between the lower outer transverse member and the upper transverse direction member.

The central transverse direction member may include a central transverse direction connecting member provided between the longitudinal direction main members and a central transverse direction outer member arranged on both outer sides of the longitudinal direction main member.

The longitudinal direction main member may include a longitudinal direction upper member disposed above and a longitudinal direction lower member disposed below the longitudinal direction upper member.

The dash reinforcement unit may further include a middle joint connecting the longitudinal direction upper member and the longitudinal direction lower member.

The middle joint may connect the central transverse direction connecting member and the central transverse direction outer member.

The middle joint may include a joint body surrounding the longitudinal direction upper member, the longitudinal direction lower member, the central transverse direction connecting member, and the central transverse direction outer member, and a joint flange connected to the dash panel.

The longitudinal member may further include a longitudinal direction sub-member disposed between the longitudinal direction main members.

The dash reinforcement unit may include a reinforcement unit flange connected to the dash panel and a reinforcement unit body formed protruding from the reinforcement unit flange.

The front structure according to exemplary embodiments may further include a fender apron reinforcement member connected to the front of the dash panel, and at least a portion of the longitudinal member may overlap the fender apron reinforcement member.

According to an embodiment of the front structure of a vehicle body, the strength of the dash panel can be reinforced to secure the stability of the vehicle.

According to an embodiment of the front structure of a vehicle body, a PBV platform for small-quantity, multi-variety production can provide a flexible vehicle body structure according to various demand conditions.

According to an embodiment of the front structure of a vehicle body, free deletion or reinforcement of component members is possible, so that the structural efficiency of the vehicle body can be increased.

In addition, the effects that can be obtained or expected from embodiments of the present invention are directly or implicitly disclosed in the detailed description of the embodiments of the present invention. That is, various effects predicted according to embodiments of the present invention will be disclosed in the detailed description to be provided later.

### BRIEF DESCRIPTION OF THE DRAWINGS

Since these drawings are for reference in explaining exemplary embodiments of the present invention, the technical ideas of the embodiments of the present invention should not be interpreted as limited to the attached drawings.

FIG. 1 is a perspective view showing a front structure of a vehicle body according to an embodiment.

FIG. 2 is a front view of a dash reinforcement unit applied to the front structure of a vehicle body according to an embodiment.

FIG. 3 is an exploded view of a dash reinforcement unit applied to the front structure of a vehicle body according to an embodiment.

FIG. 4 is a partially exploded perspective view of a dash reinforcement unit applied to the front structure of a vehicle body according to an embodiment.

FIG. 5 is a rear view of a dash panel applied to the front structure of a vehicle body according to an embodiment.

FIG. 6 is a cross-sectional view along line VI-VI of FIG. 1.

FIG. 7 is a front view of a dash reinforcement unit applied to the front structure of a vehicle body according to another embodiment.

The following reference identifiers may be used in connection with the drawings to describe various features of embodiments of the present invention.
10: vehicle body
20: chassis frame
25, 26: connection portion
30: dash panel
40: front apron member
45: fender apron reinforcement member
46: upper apron reinforcement body
47: lower apron reinforcement body
60: dash reinforcement unit
70: longitudinal member
80: longitudinal direction main member
92: longitudinal direction upper member
93: longitudinal direction upper flange
94: longitudinal direction upper body
95: longitudinal direction lower member
96: longitudinal direction lower member flange
97: longitudinal direction lower member body
100: transverse member
110: lower outer transverse member
111: lower outer transverse member flange
112: lower outer transverse member body
115: lower connecting transverse member
116: lower connecting transverse member flange
117: lower connecting transverse member body
120: upper transverse direction member
122: upper transverse direction connecting member
123: upper transverse direction connecting member flange
124: upper transverse direction connecting member body
125: upper transverse direction outer member
126: upper transverse direction outer member flange
127: upper transverse direction outer member body
130: central transverse direction member
132: central transverse direction connecting member
133: central transverse direction connecting member flange
134: central transverse direction connecting member body
135: central transverse direction outer member
136: central transverse direction outer member flange
137: central transverse direction outer member body
140: middle joint
142: joint body
144: joint flange
150: longitudinal direction sub-member

It should be understood that the drawings referenced above are not necessarily drawn to scale, but rather present rather simplified representations of various preferred features illustrating the basic principles of embodiments of the present invention.

For example, specific design features of embodiments of the present invention, including particular dimensions, orientations, locations, and shapes, will be determined in part by the particular intended application and usage environment.

### DETAILED DESCRIPTION OF ILLUSTRATIVE EMBODIMENTS

Hereinafter, with reference to the attached drawings, embodiments of the present invention will be described in detail so that a person having ordinary skill in the art to which the present invention pertains can easily practice the present invention.

As those skilled in the art would realize, the described embodiments may be modified in various different ways, all without departing from the spirit or scope of the present invention.

In order to clearly explain the embodiments of the present invention, parts irrelevant to the description are omitted, and the same reference numerals are used for identical or similar components throughout the specification.

The size and thickness of each component shown in the drawings are arbitrarily shown for convenience of explanation, and the embodiments of the present invention are not necessarily limited to what is shown in the drawings. In order to clearly express various parts and areas, the thickness is shown by enlarging it.

In addition, in the detailed description below, the names of the components are divided into first, second, etc. to distinguish them when the components are in a similar relationship, and the description below is not necessarily limited to that order.

Throughout the specification, whenever a part is said to include a certain component, this does not mean that it excludes other components, but rather that it may include other components, unless otherwise specifically stated.

Additionally, terms such as part, portion, means, etc. described in the specification mean comprehensive units of composition that perform at least one function or operation.

When a part, such as a layer, membrane, region, or plate, is referred to as being “over” another part, this includes not only cases where it is directly over the other part, but also cases where there are other parts in between.

In contrast, when an element is referred to as being “directly on” another element, there are no intervening elements present.

In this specification, the term ‘connected’ indicates that a physical relationship exists between two components, for example, in which components are directly connected to each other by welding, self piercing rivet (SPR), flow drill screw (FDS), structural adhesive, or the like, or components that are indirectly connected through one or more intermediate components.

As used herein, ‘vehicle’, ‘vehicular’, ‘automotive’ or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based purpose built vehicles (PBVs), hydrogen-powered vehicles and other alternative fuel vehicles (e.g., other than petroleum fuel derived from resources).

In this specification, the reference direction for explaining the components below may be set as the front-rear direction of the vehicle body (e.g., body length direction or longitudinal direction), the width direction (e.g., lateral direction or left-right direction), and the up-down direction (e.g., height direction or vertical direction) based on the vehicle body.

Furthermore, in this specification, ‘upper end’, ‘upper portion’, or ‘upper surface’ of a component indicates an end, portion, or surface of a component that is relatively upper in the drawing, and ‘lower end’, ‘lower portion’, or ‘lower surface’ of a component indicates an end, portion, or surface of a component that is relatively lower in the drawing.

Furthermore, in this specification, an end of a component (e.g., one end or another (other) end, etc.) denotes an end of a component in any one direction, and an end portion of the component (e.g., one end portion) or other (another) end portion, etc.) denotes a portion of a component that includes that end.

An embodiment will hereinafter be described in detail with reference to the accompanying drawings.

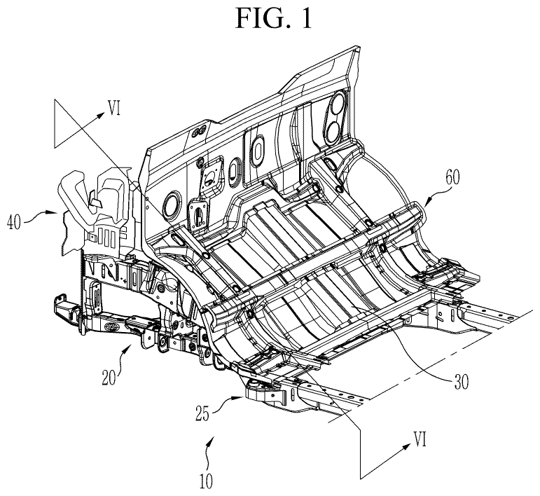

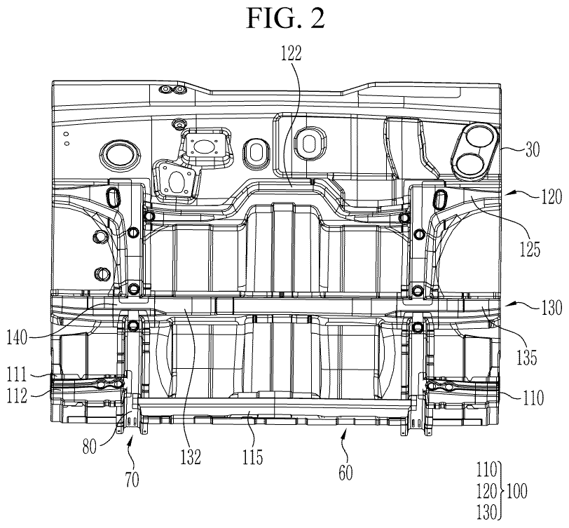

FIG. 1 is a perspective view showing a front structure of a vehicle body according to an embodiment, and FIG. 2 is a front view of a dash reinforcement unit applied to the front structure of a vehicle body according to embodiment.

Referring to FIG. 1 and FIG. 2, a front structure of a vehicle body according to an embodiment may include a dash panel 30 and a dash reinforcement unit 60 connected to a rear side of the dash panel 30 and including one or more longitudinal members 70 arranged in a length direction of a vehicle body 10 and one or more transverse members 100 arranged in a width direction of the vehicle body 10.

According to an embodiment, the front structure further includes a chassis frame 20, and the dash panel 30 may be provided on an upper portion of the chassis frame 20.

In the case of a typical monocoque vehicle, the load coming from the chassis module is supported through the fender apron elongated in the length direction of the vehicle body, and the dash panel is placed on an upper part of the fender apron to simply serve as support.

In a vehicle with a skateboard frame, the front apron cannot extend to the lower part of the dash due to the front chassis frame, so a structure that reinforces the lower part of the dash is required.

However, the vehicle to which the front structure according to an embodiment is applied is not limited to a vehicle having a skateboard frame, and it can be applied to various types of vehicle bodies that require reinforcement of the dash panel.

In the front structure of a vehicle body according to an embodiment, the dash reinforcement unit 60 is connected with the dash panel 30 to reinforce the strength of the dash panel 30 using the one or more longitudinal members 70 and the one or more transverse members 100.

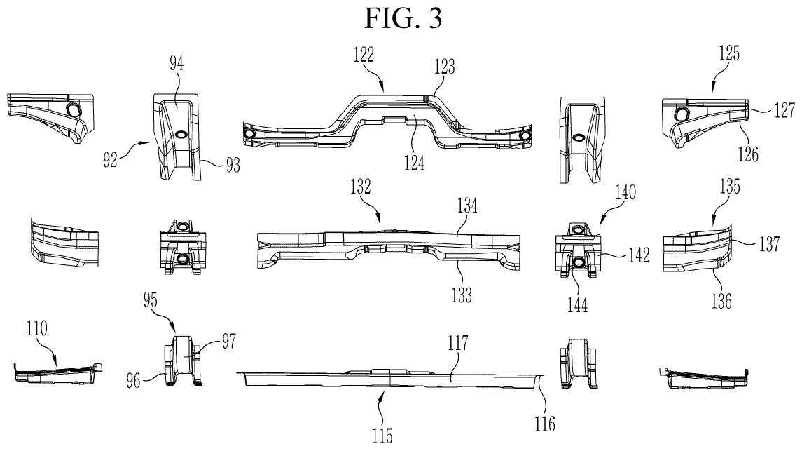

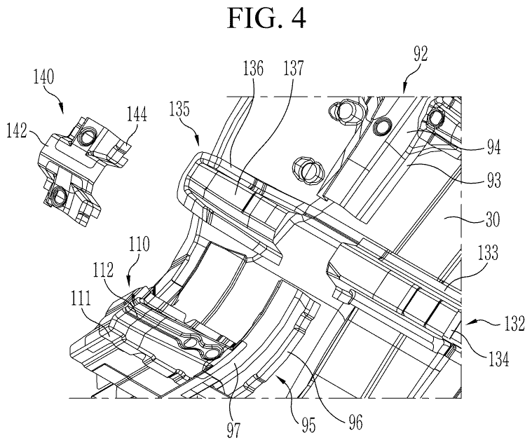

FIG. 3 is an exploded view of a dash reinforcement unit applied to the front structure of a vehicle body according to an embodiment, and FIG. 4 is a partially exploded perspective view of a dash reinforcement unit applied to the front structure of a vehicle body by an embodiment.

Referring to FIG. 1 to FIG. 4, the transverse member 100 may include a lower outer transverse member 110 that overlaps a connection portion 25 of the chassis frame 20 and the dash panel 30 and is arranged on the outer side in the width direction of the dash panel 30, respectively.

The portion 25 where the chassis frame 20 and the dash panel 30 are joined is in the rearward direction of the vehicle body 10 of the dash panel 30, so that the load transferred from the chassis frame 20 to the dash panel 30 may be concentrated.

The lower outer transverse member 110 supports the lower part of the dash panel 30 so that the load transferred to the dash panel 30 may be dispersed.

The transverse member 100 may further include a lower connecting transverse member 115 positioned between the lower outer transverse members 110 on either side.

The lower connecting transverse member 115 connects the lower outer transverse members 110 on both sides to disperse the load transmitted from the lower outer transverse member 110 and increase the transverse direction strength of the vehicle body 10.

In addition, if the vehicle type is different, the size of the vehicle body is changed, or the vehicle body design is changed, it can be easily responded to by changing the length of the lower connecting transverse member 115.

The longitudinal member 70 may include a longitudinal direction main member 80, which is arranged on both sides of the dash panel 30 and connected to the lower outer transverse member 110.

The longitudinal direction main member 80 is connected to the dash panel 30 to increase the strength of the dash panel 30 and the longitudinal direction strength of the vehicle body 10.

The transverse member 100 may include an upper transverse direction member 120 connected to the upper portion of the longitudinal direction main member 80.

The upper transverse direction member 120 is connected to the upper portion of the dash panel 30 to increase the strength of the dash panel 30 and increase the transverse direction strength of the vehicle body 10.

The upper transverse direction member 120 may include an upper transverse direction connecting member 122 provided between the longitudinal direction main members 80 and an upper transverse direction outer member 125 arranged on both outer sides of the longitudinal direction main member 80.

Even if the vehicle type is different, the size of the vehicle body is changed, or the vehicle body design is changed, it can be easily responded to by changing the length of the upper transverse direction connecting member 122.

The transverse member 100 may include a central transverse direction member 130 positioned between the lower outer transverse member 110 and the upper transverse direction member 120.

The central transverse direction member 130 may include a central transverse direction connecting member 132 provided between the longitudinal direction main members 80, and a central transverse direction outer member 135 arranged on both outer sides of the longitudinal direction main member 80.

Even if the vehicle type is different, the size of the vehicle body is changed, or the vehicle body design is changed, it can be easily responded to by changing the length of the central transverse direction connecting member 132.

The longitudinal direction main member 80 may include a longitudinal direction upper member 92 disposed above and a longitudinal direction lower member 95 disposed below the longitudinal direction upper member 92.

The longitudinal direction upper member 92 and the longitudinal direction lower member 95 are connected to form the longitudinal direction main member 80, so that even if the vehicle type is different, the size of the vehicle body is changed, the vehicle body design is changed, or the size of the transverse member 100 is changed, it can be easily responded to by changing the size of the longitudinal direction upper member 92 or the longitudinal direction lower member 95.

The dash reinforcement unit 60 may include a reinforcement unit flange connected to the dash panel 30 and a reinforcement unit body formed protruding from the reinforcement unit flange.

As shown in FIG. 2 and FIG. 3, the dash reinforcement unit 60 includes each reinforcement unit flange and the reinforcement unit body formed protruding from the reinforcement unit flange.

Specifically, the longitudinal direction upper member 92 includes a longitudinal direction upper flange 93 and a longitudinal direction upper body 94, and the longitudinal direction lower member 95 includes a longitudinal direction lower member flange 96 and a longitudinal direction lower member body 97.

The lower outer transverse member 110 includes a lower outer transverse member flange 111 and a lower outer transverse member body 112, and the lower connecting transverse member 115 includes a lower connecting transverse member flange 116 and a lower connecting transverse member body 117.

The upper transverse direction connecting member 122 includes an upper transverse direction connecting member flange 123 and an upper transverse direction connecting member body 124, and the upper transverse direction outer member 125 includes an upper transverse direction outer member flange 126 and an upper transverse direction outer member body 127.

The central transverse direction connecting member 132 includes a central transverse direction connecting member flange 133 and a central transverse direction connecting member body 134, and the central transverse direction outer member 135 includes a central transverse direction outer member flange 136 and a central transverse direction outer member body 137.

The bonding strength between the dash reinforcement unit 60 and the dash panel 30 may be increased by the respective reinforcement unit flanges 93, 96, 111, 116, 123, 126, 133, and 136 of the dash reinforcement unit 60.

The strength of the dash reinforcement unit 60 may be increased by the reinforcement unit bodies 94, 97, 112, 117, 124, 127, 134, and 137 formed by protruding from the respective reinforcement unit flanges 93, 96, 111, 116, 123, 126, 133, and 136.

The dash reinforcement unit 60 may further include a middle joint 140 connecting the longitudinal direction upper member 92 and the longitudinal direction lower member 95.

The middle joint 140 connects the longitudinal direction upper member 92 and the longitudinal direction lower member 95, thereby increasing the connection strength between the longitudinal direction upper member 92 and the longitudinal direction lower member 95, and making it easy to change the design of the longitudinal direction upper member 92 or the longitudinal direction lower member 95.

Additionally, the middle joint 140 may connect the central transverse direction connecting member 132 and the central transverse direction outer member 135.

The middle joint 140 connects the central transverse direction connecting member 132 and the central transverse direction outer member 135, thereby increasing the connection strength between the central transverse direction connecting member 132 and the central transverse direction outer member 135, and also makes it easy to change the design of the size of the central transverse direction connecting member 132 or the central transverse direction outer member 135.

Additionally, the middle joint 140 may include a joint body 142 surrounding the longitudinal direction upper member 92, the longitudinal direction lower member 95, the central transverse direction connecting member 132, and the central transverse direction outer member 135, and a joint flange 144 connected to the dash panel 30.

The joint body 142 and the joint flange 144 can increase the joint strength of the middle joint 140, and the size design of the dash reinforcement unit 60 can be easily changed.

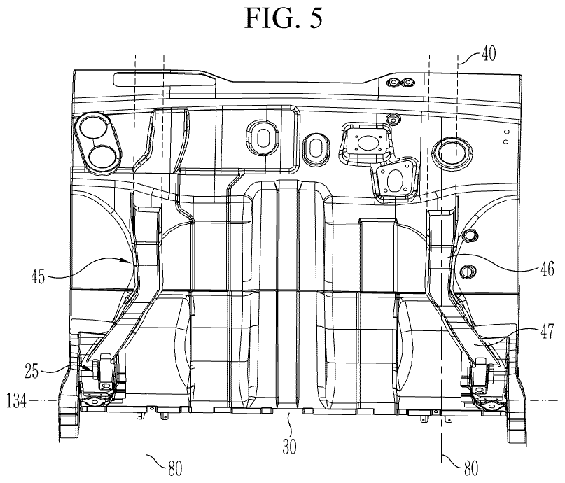

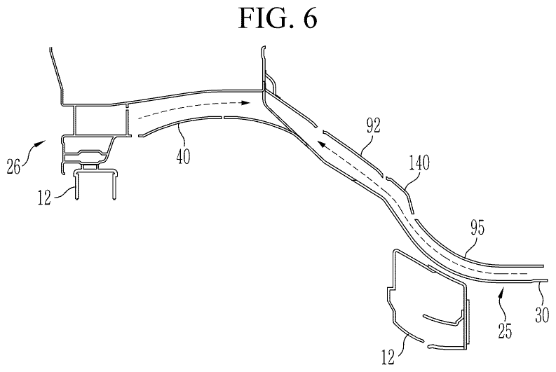

FIG. 5 is a rear view of a dash panel applied to the front structure of a vehicle body according to an embodiment, and FIG. 6 is a cross-sectional view along line VI-VI of FIG. 1.

Referring to FIG. 5 and FIG. 6, a fender apron member 40 may be connected to the chassis frame 20 at the front of the dash panel 30.

As shown in the drawing, in a vehicle with a skateboard frame, the fender apron member 40 is not extended to the lower portion of the dash panel 30 by the chassis frame 20.

The front structure of a vehicle body according to an embodiment further includes a fender apron reinforcement member 45 connected to a front of the dash panel 30.

The fender apron reinforcement member 45 may be connected to the fender apron member 40.

The fender apron reinforcement member 45 includes an upper apron reinforcement body 46 arranged in the length direction of the vehicle body 10 from the fender apron member 40 and a lower apron reinforcement body 47 bent from the upper apron reinforcement body 46 and extended to the connection portion 25.

At least a portion of the longitudinal member 70 may overlap the fender apron reinforcement member 45.

That is, the single-dot chain line depicted in the drawing indicates the joining position of the longitudinal direction main member 80 mounted at the rear of the dash panel 30, and a part of the fender apron reinforcement member 45 and the longitudinal direction main member 80 may overlap with the dash panel 30 in between.

Therefore, the load transmitted from the connection portion 25 of the chassis frame 20 and the dash panel 30 may be dispersed to the vehicle body 10 through the longitudinal direction main member 80 and the fender apron reinforcement member 45.

The connection portion 25 of the chassis frame 20 and the dash panel 30, where the load may be concentrated, and the portion 26 connected to the fender apron member 40 and the chassis frame 20 are connected to the fender apron member 40 and the dash reinforcement unit 60, so that the load of the vehicle body may be easily dispersed.

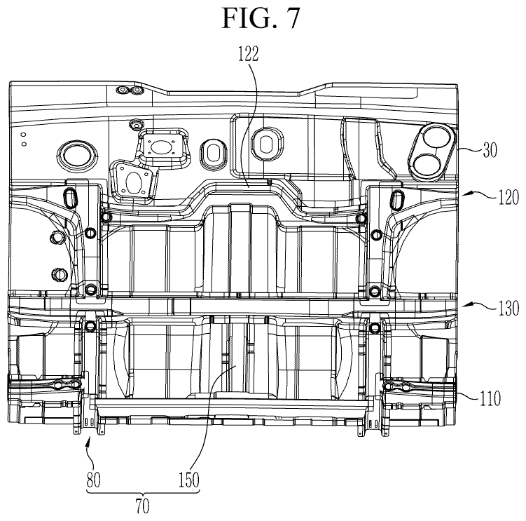

FIG. 7 is a front view of a dash reinforcement unit applied to the front structure of a vehicle body according to another embodiment.

Referring to FIG. 7, the longitudinal member 70 may further include a longitudinal direction sub-member 150 arranged between the longitudinal direction main members 80.

The longitudinal direction sub-member 150 may increase the lower longitudinal direction strength of the dash panel 30.

Each configuration of the dash reinforcement unit 60 applied to the front structure of a vehicle body according to an embodiment, as shown in FIG. 1 to FIG. 5, has a lattice shape and may increase the strength of the vehicle body 10 in the width direction and longitudinal direction.

Additionally, as shown in FIG. 7, depending on the type of vehicle, specifications or consumer requirements, the dash reinforcement unit 60 may increase the strength of the dash panel 30 by adding additional longitudinal direction members or transverse direction members or changing the size.

Conversely, to reduce vehicle weight, components that have a relatively low impact on performance, such as the lower connecting transverse member 115, may be deleted.

In this way, according to an embodiment of the front structure of a vehicle body, the strength of the dash panel is reinforced to secure the stability of the vehicle.

According to an embodiment of the front structure of a vehicle body, a PBV platform for small-quantity, multi-variety production may provide a flexible vehicle body structure according to various demand conditions.

According to an embodiment of the front structure of a vehicle body, free deletion or reinforcement of component members is possible, so that the structural efficiency of the vehicle body can be increased.

While embodiments of this invention have been described in connection with what is presently considered to be practical embodiments, it is to be understood that the embodiments of the present invention are not limited to the disclosed embodiments. On the contrary, they are intended to cover various modifications and equivalent arrangements included within the spirit and scope of the appended claims.

What is claimed is:

1. A front structure of a vehicle body, the front structure comprising:
a dash panel; and
a dash reinforcement apparatus connected to a rear of the dash panel, the dash reinforcement apparatus comprising:
a longitudinal member arranged in a length direction of the vehicle body; and
a transverse member arranged in a width direction of the vehicle body.

2. The front structure of claim 1, further comprising a chassis frame, wherein the dash panel is disposed on an upper portion of the chassis frame.

3. The front structure of claim 2, wherein the transverse member is one of a pair of lower outer transverse members that overlaps a connection portion of the chassis frame and the dash panel and is arranged on outer sides in a width direction of the dash panel, respectively.

4. The front structure of claim 3, further comprising a lower connecting transverse member disposed between the lower outer transverse members arranged on the outer sides.

5. The front structure of claim 4, wherein the longitudinal member is one of a pair of longitudinal direction main members, which is arranged on both sides of the dash panel and connected to the lower outer transverse members, respectively.

6. The front structure of claim 5, further comprising an upper transverse direction member connected to upper portions of the longitudinal direction main members.

7. The front structure of claim 6, wherein the upper transverse direction member comprises:
an upper transverse direction connecting member disposed between the longitudinal direction main members; and
a pair of upper transverse direction outer members arranged on both outer sides of the longitudinal direction main members, respectively.

8. The front structure of claim 6, further comprising a central transverse direction member disposed between the lower outer transverse members and the upper transverse direction member.

9. The front structure of claim 8, wherein the central transverse direction member comprises:
a central transverse direction connecting member disposed between the longitudinal direction main members; and
a central transverse direction outer member arranged on both outer sides of the longitudinal direction main members.

10. The front structure of claim 9, wherein the pair of longitudinal direction main members comprises:
a longitudinal direction upper member; and
a longitudinal direction lower member disposed below the longitudinal direction upper member.

11. The front structure of claim 10, wherein the dash reinforcement apparatus further comprises a middle joint connecting the longitudinal direction upper member and the longitudinal direction lower member.

12. The front structure of claim 11, wherein the middle joint connects the central transverse direction connecting member and the central transverse direction outer member.

13. The front structure of claim 12, wherein the middle joint comprises:
a joint body surrounding the longitudinal direction upper member, the longitudinal direction lower member, the central transverse direction connecting member, and the central transverse direction outer member; and
a joint flange connected to the dash panel.

14. The front structure of claim 5, wherein the longitudinal member further comprises a longitudinal direction sub-member disposed between the longitudinal direction main members.

15. The front structure of claim 1, wherein the dash reinforcement apparatus comprises:
a reinforcement unit flange connected to the dash panel; and
a reinforcement unit body formed protruding from the reinforcement unit flange.

16. The front structure of claim 1, further comprising a fender apron reinforcement member connected to a front of the dash panel, wherein at least a portion of the longitudinal members overlaps the fender apron reinforcement member.

17. A vehicle comprising:
a vehicle body;
a dash panel coupled to the vehicle body; and
a dash reinforcement apparatus connected to a rear of the dash panel, the dash reinforcement apparatus comprising:
a plurality of longitudinal members arranged in a length direction of the vehicle body; and
a plurality of transverse members arranged in a width direction of the vehicle body.

18. The vehicle of claim 17, further comprising a chassis frame, wherein the dash panel is disposed on an upper portion of the chassis frame.

19. The vehicle of claim 18, wherein:
the plurality of transverse members comprises:
a pair of lower outer transverse members which overlaps a connection portion of the chassis frame and the dash panel and is arranged on outer sides in a width direction of the dash panel, respectively; and
a lower connecting transverse member disposed between the lower outer transverse members arranged on the outer sides; and
the plurality of longitudinal members comprises a pair of longitudinal direction main members, which is arranged on both sides of the dash panel and connected to the lower outer transverse members, respectively.

20. The vehicle of claim 19, wherein the plurality of transverse members comprises an upper transverse direction member connected to upper portions of the longitudinal direction main members, the upper transverse direction member comprising:
an upper transverse direction connecting member disposed between the longitudinal direction main members; and
a pair of upper transverse direction outer members arranged on both outer sides of the longitudinal direction main members, respectively.
